(19) United States
(12) Patent Application Publication
(10) Pub. No.: US 2025/0124109 A1
(43) Pub. Date: Apr. 17, 2025

(54) EVALUATION APPARATUS, EVALUATION METHOD, AND STORAGE MEDIUM

(71) Applicant: NEC Corporation, Tokyo (JP)

(72) Inventors: Katsushi MATSUDA, Tokyo (JP); Takao Osaki, Tokyo (JP)

(73) Assignee: NEC Corporation, Tokyo (JP)

(21) Appl. No.: 18/906,319

(22) Filed: Oct. 4, 2024

(30) Foreign Application Priority Data
Oct. 17, 2023 (JP) 2023-178948

(51) Int. Cl. G06F 18/23213

(52) U.S. Cl. CPC G06F 18/23213

(57) ABSTRACT

Provided is an evaluation apparatus that narrows down a cause of a case where performance of a language processing model is not satisfactory. An evaluation apparatus includes: an acquisition section for acquiring embeddings for natural language sentences that are respectively included in a plurality of training data pieces, the embeddings having been generated with use of an embedding layer included in a language processing model; a clustering section for carrying out clustering of the embeddings; a calculation section for calculating, with reference to labels included in the respective plurality of training data pieces, an evaluation index indicating an evaluation of a result of the clustering; and an evaluation section for evaluating quality of the embedding layer based on the evaluation index. Thus, it is possible to optimize performance of a language processing model which has been subjected to machine learning.

This Nonprovisional application claims priority under 35 U.S.C. § 119 on Patent Application No. 2023-178948 filed in Japan on Oct. 17, 2023, the entire contents of which are hereby incorporated by reference.

### TECHNICAL FIELD

The present disclosure relates to a technique to evaluate performance of a language processing model.

### BACKGROUND ART

In recent years, it is known that a language processing model which carries out an intended language processing task is generated by fine-tuning a general-purpose natural language processing model as a pre-trained model. Performance of such a language processing model is affected by, for example, training data used to generate the language processing model, a pre-trained model, a training algorithm, hyperparameters employed in the language processing model, and the like. For the purpose of improving performance of such a language processing model, it is known to use, for example, a technique (such as grid search) for adjusting hyperparameters. For example, Patent Literature 1 discloses a technique for improving quality of training data.

### CITATION LIST

### Patent Literature

### Patent Literature 1

Japanese Patent Application Publication Tokukai No. 2023-19341

### SUMMARY OF INVENTION

### Technical Problem

However, in a case where the performance of the language processing model is not satisfactory, it is difficult to narrow down which one of the training data, the pre-trained model, the training algorithm, the hyperparameters, and the like as described above mainly causes the unsatisfactory performance. The technique disclosed in Patent Literature 1 is effective in a case where it is known that the main cause of the unsatisfactory performance is in quality of the training data. In the other cases, however, there is a possibility that the performance of the language processing model cannot be improved even if the quality of the training data is improved. Therefore, it is important to narrow down the cause of a case where the performance of the language processing model is not satisfactory.

The present disclosure is accomplished in view of the above problem, and an example object thereof is to provide a technique for narrowing down a cause of a case where performance of a language processing model is not satisfactory.

### Solution to Problem

An evaluation apparatus in accordance with an example aspect of the present disclosure includes at least one processor, the at least one processor carrying out: an acquisition process of acquiring embeddings for natural language sentences that are respectively included in a plurality of training data pieces, the embeddings having been generated with use of an embedding layer included in a language processing model; a clustering process of carrying out clustering of the embeddings; a calculation process of calculating, with reference to labels included in the respective plurality of training data pieces, an evaluation index indicating an evaluation of a result of the clustering; and an evaluation process of evaluating quality of the embedding layer based on the evaluation index.

An evaluation method in accordance with an example aspect of the present disclosure includes: an acquisition process in which at least one processor acquires embeddings for natural language sentences that are respectively included in a plurality of training data pieces, the embeddings having been generated with use of an embedding layer included in a language processing model; a clustering process in which the at least one processor carries out clustering of the embeddings; a calculation process in which the at least one processor calculates, with reference to labels included in the respective plurality of training data pieces, an evaluation index indicating an evaluation of a result of the clustering; and an evaluation process in which the at least one processor evaluates quality of the embedding layer based on the evaluation index.

A non-transitory storage medium in accordance with an example aspect of the present disclosure stores a program for causing a computer to function as an evaluation apparatus, the program causing the computer to carry out: an acquisition process of acquiring embeddings for natural language sentences that are respectively included in a plurality of training data pieces, the embeddings having been generated with use of an embedding. layer included in a language processing model; a clustering process of carrying out clustering of the embeddings; a calculation process of calculating, with reference to labels included in the respective plurality of training data pieces, an evaluation index indicating an evaluation of a result of the clustering; and an evaluation process of evaluating quality of the embedding layer based on the evaluation index.

### Advantageous Effects of Invention

According to an example aspect of the present disclosure, it is possible to bring about an example advantage of providing a technique to narrow down a cause of a case where performance of a language processing model is not satisfactory.

### BRIEF DESCRIPTION OF DRAWINGS

FIG. 1 is a block diagram illustrating a configuration of an evaluation apparatus in accordance with the present disclosure.

FIG. 2 is a flowchart illustrating a flow of an evaluation method in accordance with the present disclosure.

FIG. 3 is a block diagram illustrating a configuration of an evaluation system in accordance with the present disclosure.

FIG. 4 is a flowchart for describing a flow of an evaluation method in accordance with the present disclosure.

FIG. 5 is a schematic diagram illustrating an example of an embedding set in accordance with the present disclosure.

FIG. 6 is a scatter diagram illustrating an example of an embedding set in accordance with the present disclosure.

FIG. 7 is a schematic diagram illustrating an example of a result of clustering carried out a plurality of times in accordance with the present disclosure.

FIG. 8 is a flowchart illustrating a detailed example of a calculation process in accordance with the present disclosure.

FIG. 9 is a diagram illustrating an example of an evaluation index series in accordance with the present disclosure.

FIG. 10 is a diagram for describing a first example of a determination criterion in accordance with the present disclosure.

FIG. 11 is a diagram for describing a second example of a determination criterion in accordance with the present disclosure.

FIG. 12 is a flowchart illustrating a detailed example of a calculation process in accordance with the present disclosure.

FIG. 13 is a flowchart illustrating a detailed example of a calculation process in accordance with the present disclosure.

FIG. 14 is a scatter diagram illustrating embeddings in accordance with the present disclosure.

FIG. 15 is a diagram for describing an example of an evaluation result in accordance with the present disclosure.

FIG. 16 is a diagram for describing an example of an evaluation result in accordance with the present disclosure.

FIG. 17 is a block diagram illustrating a configuration example of a computer that functions as each of apparatuses in accordance with the present disclosure.

### EXAMPLE EMBODIMENTS

The inventors of the present invention have focused attention on a fact that a cause of a case where performance of a language processing model is not satisfactory can be narrowed down according to quality of an embedding layer included in the language processing model, and have invented an evaluation apparatus for evaluating quality of an embedding layer. If performance of a language processing model is poor despite good quality of an embedding layer, it is highly likely that a cause thereof is in a language processing task layer (e.g., hyperparameters). Meanwhile, in a case where quality of an embedding layer is not satisfactory, it is highly likely that there is a problem in training data, a pre-trained model, or a training algorithm related to a generation process of the embedding layer. Thus, by using the evaluation apparatus in accordance with an example aspect of the present invention, it is possible to narrow down, according to a result of evaluating quality of an embedding layer, a cause of a case where performance of a language processing model is not satisfactory.

The following description will discuss example embodiments of the present invention. The present invention is not limited to the example embodiments below, but may be altered in various ways by a skilled person within the scope of the claims. For example, the present invention can also encompass, in its scope, any example embodiment derived by appropriately combining technical means employed in the example embodiments described below. Alternatively, the present invention also encompasses, in its scope, any example embodiment derived by appropriately omitting part of technical means employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Evaluation Apparatus 1)

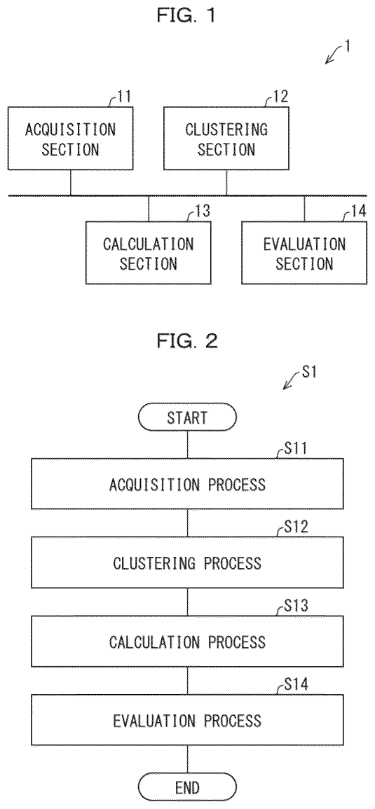

The following description will discuss a configuration of an evaluation apparatus 1, with reference to FIG. 1. FIG. 1 is a block diagram illustrating the configuration 41 the evaluation apparatus 1. As illustrated in FIG. 1, the evaluation apparatus 1 includes an acquisition section 11, a clustering section 12, a calculation section 13, and an evaluation section 14. The acquisition section 11 is an example configuration for realizing the acquisition means. The clustering section 12 is an example configuration for realizing the clustering means. The calculation section 13 is an example configuration for realizing the calculation means. The evaluation section 14 is an example configuration for realizing the evaluation means. The acquisition section 11 acquires embeddings for natural language sentences that are respectively included in a plurality of training data pieces, the embeddings having been generated with use of an embedding layer included in a language processing model. The clustering section 12 carries out clustering of a plurality of embeddings. The calculation section 13 calculates, with reference to labels included in the respective plurality of training data pieces, an evaluation index indicating an evaluation of a result of clustering. The evaluation section 14 evaluates quality of the embedding layer based on the evaluation index.

### (Example Advantage of Evaluation Apparatus 1)

As described above, the evaluation apparatus 1 employs the configuration of including the acquisition section 11, the clustering section 12, the calculation section 13, and the evaluation section 14 which are described above. Therefore, according to the evaluation apparatus 1, it is possible to bring about an example advantage of providing a technique to narrow down, according to a result of evaluating an embedding layer, a cause of a case where performance of a language processing model is not satisfactory.

### (Example of Implementation by Program)

In a case where the evaluation apparatus 1 is configured by a computer including at least one processor and a memory, the following program in accordance with the present example embodiment is stored in the memory. The program causes a computer to function as the evaluation apparatus 1, and causes the computer to function as the acquisition section 11, the clustering section 12, the calculation section 13, and the evaluation section 14 which are described above.

### (Flow of Evaluation Method S1)

The following description will discuss a flow of the evaluation method S1, with reference to FIG. 2. FIG. 2 is a flowchart illustrating the flow of the evaluation method S1. As illustrated in FIG. 2, the evaluation method S1 includes an acquisition process S11, a clustering process S12, a calculation process S13, and an evaluation process S14. In the acquisition process S11, the at least one processor acquires embeddings for natural language sentences that are respectively included in a plurality of training data pieces, the embeddings having been generated with use of an embedding layer included in a language processing model. In the clustering process S12, the at least one processor carries out clustering of a plurality of embeddings. In the calculation process S13, the at least one processor calculates, with reference to labels included in the respective plurality of training data pieces, an evaluation index indicating an evaluation of a result of clustering. In the evaluation process S14, the at least one processor evaluates quality of the embedding layer based on the evaluation index.

### (Example Advantage of Evaluation Method S1)

As described above, the evaluation method S1 employs the configuration of including the acquisition process S11, the clustering process S12, the calculation process S13, and the evaluation process S14 which are described above. Therefore, according to the evaluation method S1, it is possible to bring about an example advantage of providing a technique to narrow down, according to a result of evaluating an embedding layer, a cause of a case where performance of a language processing model is not satisfactory.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of technical means which are employed in the present example embodiment is not limited to the present example embodiment. That is, technical means employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Evaluation Apparatus 1A)

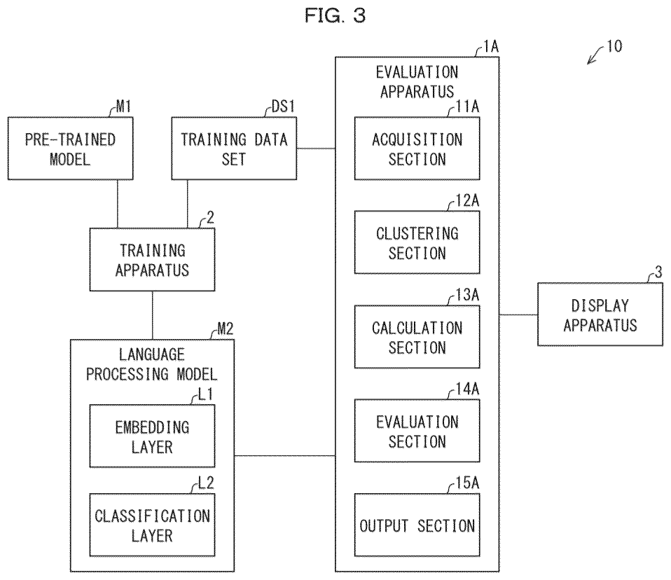

FIG. 3 is a block diagram illustrating a configuration of an evaluation system 10 including the evaluation apparatus 1A. As illustrated in FIG. 3, the evaluation system 10 includes the evaluation apparatus 1A, a training apparatus 2, and a display apparatus 3. The evaluation apparatus 1A and the training apparatus 2 may be communicably connected to each other. Note, however, that the evaluation apparatus 1A and the training apparatus 2 do not need to be able to communicate with each other, and do not need to be connected to each other. The display apparatus 3 is connected to the evaluation apparatus 1A and displays information under control of the evaluation apparatus 1A.

The evaluation apparatus 1A is an apparatus for evaluating quality of an embedding layer included in a language processing model M2. In the present example embodiment, a deep learning model which carries out a classification task of natural language sentences is applied as the language processing model M2. The language processing model M2 has been trained, upon receipt of input of a natural language sentence, to output a classification of the natural language sentence.

The training apparatus 2 is an apparatus which generates a language processing model M2 by fine-tuning a pre-trained model M1 with use of a training data set DS1. The training data set DS1 and the language processing model M2 are stored in a storage apparatus (not illustrated) which is accessible from the evaluation apparatus 1A. In the present example embodiment, an example will be described in which the evaluation apparatus 1A refers to the training data set DS1 which has been used for generation of the language processing model M2. Note, however, that part or all of the training data set DS1 that is referred to by the evaluation apparatus 1A does not necessarily need to be a training data set used for generation of the language processing model M2, and may be a training data set for evaluation.

The pre-trained model M1 outputs, upon receipt of input of a natural language sentence, an embedding of the natural language sentence. An embedding expresses a natural language sentence as a vector in a higher dimensional feature quantity space. Elements of an embedding are numerical values, that is, an embedding is a numerical representation of a natural language sentence. Examples of the pre-trained model M1 include bidirectional encoder representations from transformers (BERT), generative pre-trained transformer (GPT), text-to-text transfer transformer (T5), and the like. For example, an embedding outputted by bert-base-japanese-whole-word-masking (Japanese BERT) is a 768-dimensional vector. An embedding outputted by Japanese-gpt2-medium (Japanese GPT2) is a 1024-dimensional vector. An embedding outputted by t5-base-japanese (Japanese T5) is a 768-dimensional vector. Note, however, that the pre-trained model M1 is not limited to the above-described examples.

The training data set DS1 includes a plurality of training data pieces. A training data piece includes information (hereinafter, also referred to as a pair) in which a natural language sentence is associated with a label indicating a classification of the natural language sentence. For example, it is assumed that a label “TRUE” indicates a classification in which a natural language sentence associated with the label is correct information, and a label “FALSE” indicates a classification in which an associated natural language sentence is incorrect information. In this case, examples of the training data piece include a pair of a label “TRUE” and a natural language sentence “The capital of Japan is Tokyo”, a pair of a label “FALSE” and a natural language sentence “Osaka is the most populated prefecture in Japan”, and the like. As another example, the training data set DS1 may be constituted by training data pieces each including (i) an article included in a news corpus as a natural language sentence and (ii) a category of the article as a label. Note that a field of a natural language sentence and a type of a label which are included in a training data piece are not limited to the above described example. The number of label types included in the training data set DS1 is preferably two or more.

The language processing model M2 is a model that is generated by fine-tuning the pre-trained model M1 by the training apparatus 2 using the training data set DS1. The language processing model M2 includes an embedding layer L1 and a classification layer L2. The embedding layer L1 is a layer that, upon receipt of input of a natural language sentence, outputs an embedding of the natural language sentence. For input of the same natural language sentence, an embedding output from the embedding layer L1 and an embedding output from the pre-trained model M1 may not necessarily be the same, and may be different from each other. This is because the embedding layer L1 is fine-tuned based on the pre-trained model M1. The classification layer L2 is a layer that, upon receipt of input of an embedding, outputs a classification of the embedding. The language processing model M2 is trained so that, in a case where a natural language sentence of a training data piece is input to the embedding layer L1, a label associated with the natural language sentence is output from the classification layer L2.

The evaluation apparatus 1A includes an acquisition section 11A, a clustering section 12A, a calculation section 13A, an evaluation section 14A, and an output section 15A. The acquisition section 11A acquires, for natural language sentences included in respective training data pieces of the training data set DS1, embeddings generated by using the embedding layer L1 included in the language processing model M2.

The clustering section 12A carries out clustering of a plurality of embeddings a plurality of times while varying the number of clusters. The number of times in which clustering is carried out while varying the number of clusters only needs to be two or more, and is not particularly limited. For example, the clustering section 12A may apply, as the number of clusters, a number M=N×m obtained by multiplying the number N of label types included in the training data set DS1 by m (m=1, 2, 3, . . . ). In other words, the number M of clusters may be a multiple of the number N of label types. In the description below, a case where m=1 is omitted because a possibility that a label and a clustering completely match each other seems to be low, and therefore cases where m=2, 3, . . . will be described. For example, in a case where a label is given to a training data piece using a deep neural network (DNN), classification by DNN is nonlinear. Therefore, it is possible to consider that a classification (label) by DNN and a linear clustering hardly match each other completely. Note, however, that m is not limited to start from 2. A plurality of embeddings acquired by the acquisition section 11A are clustered into M clusters. Note that a known technique can be applied as a clustering method. Examples of an applicable clustering method include, but not limited to, a k-means method which is an example of a non-hierarchical method.

The calculation section 13A calculates an evaluation index with reference to a cluster that satisfies an occupancy condition among a plurality of clusters indicated by a result of clustering, the occupancy condition being a condition for regarding a cluster of interest as being occupied by a plurality of embeddings which have been generated from a plurality of training data pieces including the same label. Here, an “embedding generated from a training data piece including a certain label” represents a natural language sentence associated with the certain label in the training data piece. Hereinafter, in order to simplify the description, an “embedding generated from a training data piece including a certain label” is also referred to as an “embedding associated with a certain label”. In other words, a state in which a cluster satisfies the occupancy condition means that the cluster is regarded as being occupied by embeddings which are associated with a certain label. The cluster satisfying the occupancy condition is highly likely to appropriately correspond to the certain label. Therefore, as the number of clusters which satisfy the occupancy condition increases, a result of clustering is highly likely to be adequate. Therefore, it is possible to calculate an evaluation index by referring to a cluster which satisfies the occupancy condition.

The evaluation section 14 evaluates quality of the embedding layer L1 based on evaluation indices indicating evaluations of respective results of clustering carried out a plurality of times. Hereinafter, the “evaluation indices indicating evaluations of respective results of clustering carried out a plurality of times” are also referred to as an “evaluation index series”. For example, the evaluation section 14 may determine whether or not the embedding layer L1 is appropriate based on whether or not an evaluation index series satisfies a determination criterion. Details of the determination criterion will be described later.

In a case where the same training data set DS1 is used to obtain both a first evaluation result and a second evaluation result, and neither the first evaluation result nor the second evaluation result satisfies a determination criterion, the evaluation section 14A evaluates that quality of the training data set DS1 does not satisfy a criterion. Here, the first evaluation result is a result of evaluating quality of the embedding layer obtained by causing the acquisition section 11A, the clustering section 12A, the calculation section 13A, and the evaluation section 14A to function while applying the language processing model M2 as the language processing model. The second evaluation result is a result of evaluating quality of the embedding layer obtained by causing the acquisition section 11A, the clustering section 12A, the calculation section 13A, and the evaluation section 14A to function while applying a language processing model M2-1 as the language processing model. The language processing model M2-1 is a model different from the language processing model M2. For example, the language processing model M2-1 can be a model that is generated by fine-tuning a pre-trained model M1-1, which is different from the pre-trained model M1, using the same training data set DS1.

The output section 15A outputs at least one selected from the group consisting of a result of evaluating quality of the embedding layer L1, a result of clustering, and an evaluation index. The output section 15A is an example configuration for realizing the output means.

### (Flow of Evaluation Method S1A)

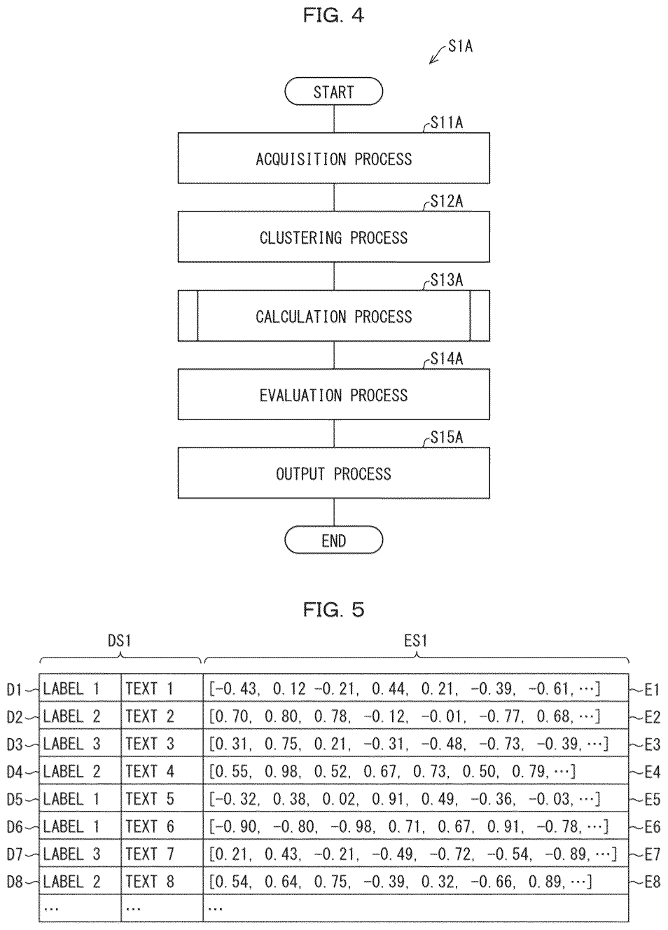

The evaluation apparatus 1A configured as described above carries out an evaluation method S1A. The following description will discuss a flow of the evaluation method S1A, with reference to FIG. 4. FIG. 4 is a flowchart for describing the flow of the evaluation method S1A. As illustrated in FIG. 4, the evaluation method S1A includes steps S11A through S15A.

In step S11A, the acquisition section 11A acquires embeddings of natural language sentences included in respective training data pieces of the training data set DS1, using the embedding layer L1 included in the language processing model M2.

FIG. 5 is a schematic diagram illustrating an example of embeddings acquired in step S11A. The training data set DS1 illustrated in FIG. 5 includes training data pieces D1 through D8. For example, the training data piece D1 includes a pair of a label “Label 1” and a natural language sentence “Text 1”. The label “Label 1” indicates a classification of the natural language sentence “Text 1”. An embedding E1 is an embedding obtained by inputting the natural language sentence “Text 1” into the embedding layer L1 of the language processing model M2, and elements thereof are expressed by numerical values. The training data pieces D2 through D8 and embeddings E2 through E8 are also described in a manner similar to the training data piece D1 and the embedding E1. As described above, for example, an “embedding E1” acquired from “text 1” associated with a “label 1” is also referred to as an “embedding E1 associated with a label 1” and the like. In the training data set DS1, the label is assumed to be any one of a “label 1”, a “label 2”, and a “label 3”, and the number N of label types is assumed to be 3. Thus, an embedding set ES1 is generated from the training data set DS1.

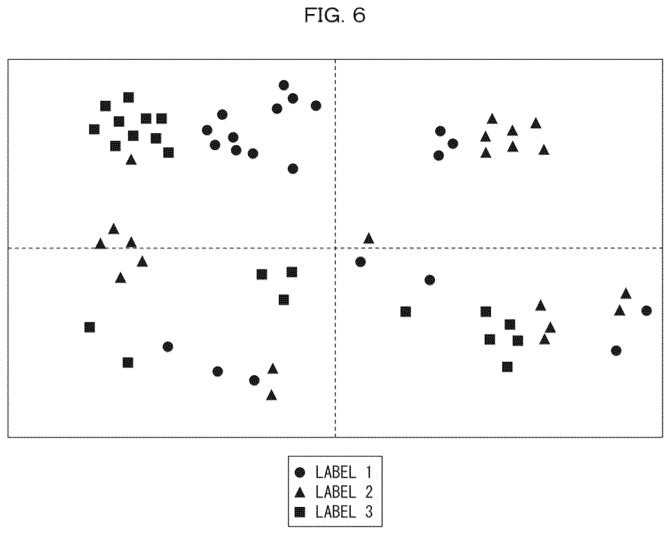

FIG. 6 is a scatter diagram illustrating the embedding set ES1 illustrated in FIG. 5. In the scatter diagram, a higher dimensional (e.g., the number of dimensions of the pre-trained model M1) embedding is compressed to two dimensions and plotted. In the example of FIG. 6, 63 training data pieces are included in the training data set DS. Therefore, figures indicating 63 embeddings are plotted. Embeddings associated with the “label 1” are each indicated by a black circle. Embeddings associated with the “label 2” are each indicated by a black triangle. Embeddings associated with the “label 3” are each indicated by a black quadrangle. The number of embeddings associated with each label is 21.

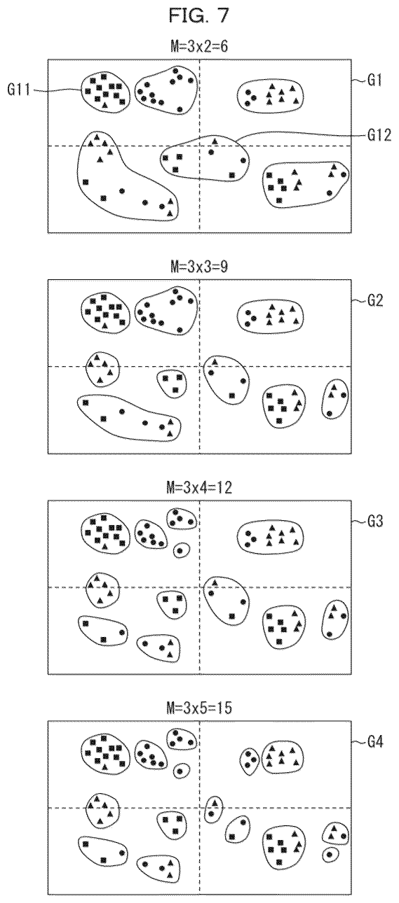

In step S12A illustrated in FIG. 4, the clustering section 12A carries out clustering of a plurality of embeddings a plurality of times while varying the number of clusters. FIG. 7 is a schematic diagram illustrating a result of clustering carried out with respect to the embedding set ES1 illustrated in FIG. 6 a plurality of times while varying the number of clusters. In clustering results G1 through G4, a line surrounding a plurality of embeddings indicates a cluster. For example, in the clustering result G1, the number M of clusters is 6 obtained by multiplying the number N of label types (=3) by m (=2). In the clustering result G2, the number M of clusters is 9 obtained by multiplying N (=3) by m (=3). In the clustering result G3, the number M of clusters is 12 obtained by multiplying N (=3) by m (=4). In the clustering result G4, the number M of clusters is 15 obtained by multiplying N (=3) by m (=5). That is, in this example, the number of clusters is a multiple of 3, which is the number of label types. As such, FIG. 7 illustrates results of clustering of 4 times, where the numbers of clusters are 6, 9, 12, and 15, respectively. The number of times of clustering is assumed to be approximately 3 to 10 times. Note, however, that the number of times of clustering is not limited to this range, and may be set in accordance with evaluation accuracy or calculation cost.

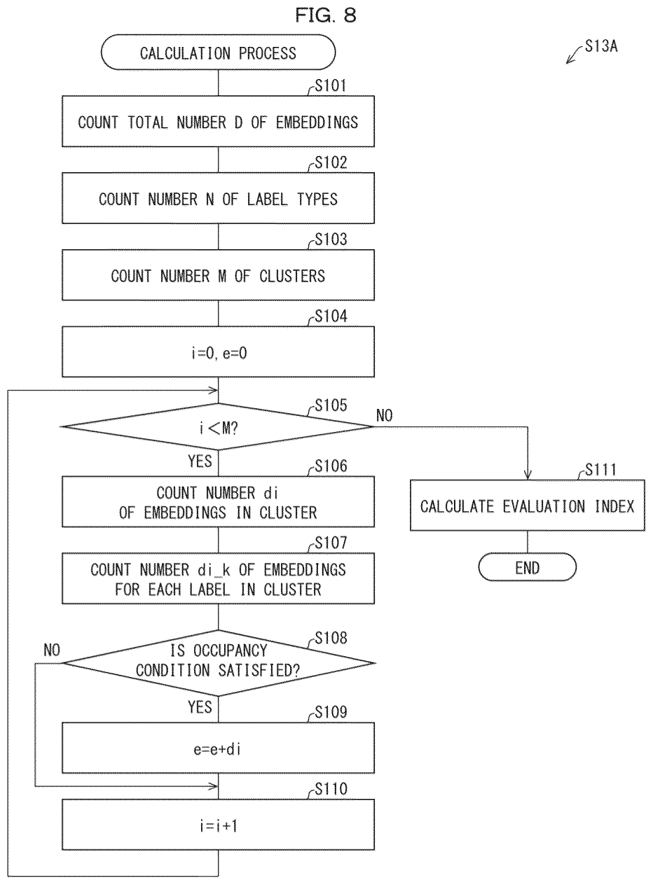

In step S13A illustrated in FIG. 4, the calculation section 13A calculates an evaluation index with reference to a cluster that satisfies an occupancy condition among a plurality of clusters indicated by a result of clustering. For example, the calculation section 13A calculates, as the evaluation index, a ratio of a total number of embeddings included in one or more clusters that satisfy the occupancy condition relative to a total number of a plurality of embeddings which have been acquired from the training data set DS1. The following description will discuss a detailed example of step S13A, with reference to FIG. 8.

FIG. 8 is a flowchart illustrating a detailed example of a calculation process in step S13A. In the description below, each of M clusters indicated by the clustering result are referred to as an i-th cluster (i=0, 1, . . . , M-1) based on the order of processes. The order of processes may be arbitrarily set and, for example, an i-th cluster may be selected randomly from clusters which have not been processed yet. As illustrated in FIG. 8, the calculation process S13A includes steps S101 through S111. Steps S101 through S111 indicate a series of processes which is carried out for a single clustering result, and is repeated by the number of times clustering is carried out. The following description will mainly discuss an example in which steps S101 through S111 are carried out for the clustering result G1. Steps S101 through S111 are carried out similarly also for each of the clustering results G2 through G4.

In step S101, the calculation section 13A counts a total number D of embeddings which have been subjected to clustering. In the example of FIG. 6, the training data set DS1 includes 63 training data pieces D, and therefore D is 63.

In step S102, the calculation section 13A counts the number N of label types. In the example of FIG. 6, as described above, the training data set DS1 includes three types of labels, that is, the label 1, the label 2, and the label 3. Therefore, the number N of label types is 3.

In step S103, the calculation section 13A counts the number M of clusters. For example, in the clustering result G1 illustrated in FIG. 7, M is 6.

In step S104, the calculation section 13A initializes, to 0, an iterator i for sequentially processing a plurality of clusters which are included in a result of clustering of interest. Moreover, the calculation section 13A initializes, to 0, a variable e for counting a total number of embeddings included in a cluster that satisfies the occupancy condition.

In step S105, the calculation section 13A determines whether or not i is smaller than M (that is, whether or not there is a cluster which has not been processed yet). In a case where it has been determined to be Yes in step S105, a series of processes in subsequent steps S106 through S109 is carried out with respect to an i-th cluster. A case in which it has been determined to be No in step S105 will be described later.

In step S106, the calculation section 13A counts a number di of embeddings which are included in the i-th cluster. For example, it is assumed that a cluster G11 is processed 0th in the clustering result G1 illustrated in FIG. 7. In this case, a number d0 of embeddings included in the cluster G11 is 11.

In step S107, the calculation section 13A counts a number dk of embeddings which are associated with each of k-th (k=1, 2, . . . , N) labels in N types of labels in the i-th cluster. For example, it is assumed that a cluster G11 is processed 0th in the clustering result G1 illustrated in FIG. 7. In this case, a number d0_1 of embeddings associated with the 1st label “label 1” is 0. A number d0_2 of embeddings associated with the 2nd label “label 2” is 1. A number d0_3 of embeddings associated with the 3rd label “label 3” is 10.

In step S108, the calculation section 13A determines whether or not the i-th cluster satisfies the occupancy condition. As described above, the occupancy condition is a condition for regarding a certain cluster as being occupied by embeddings which are associated with the same label. The occupancy condition may be a condition that, for example, a ratio of embeddings associated with the same label in a certain cluster is equal to or greater than a threshold T. Note, however, that the occupancy condition is not limited to the above-described example. A ratio of embeddings associated with the same label in a cluster is obtained according to a calculation formula “di_k/di”. The threshold T may be a predetermined proportion (e.g., 70% or the like) or may be calculated based on a calculation formula for calculating the threshold T. An example of such a calculation formula is indicated by the following formula (1).

$$T = 1 - 1 / N \qquad ( 1 )$$

In the formula (1), N represents the number of types of labels. For example, in the training data set DS1 illustrated in FIG. 6, the number N of label types is 3, and therefore T=1−1/3≈0.67.

For example, it is assumed that a cluster G11 is processed 0th in the clustering result G1 illustrated in FIG. 7. In the cluster G11, a ratio of embeddings associated with the label 3 is calculated to be 10/11≈0.91 based on the number d0_3 of embeddings=10 and the number d0 of embeddings included in the cluster G11=11. The ratio of 0.91 is greater than the threshold T=0.67. Therefore, the cluster G11 satisfies the occupancy condition. In other words, the cluster G11 is occupied by embeddings which are associated with the label 3.

For example, it is assumed that a cluster G12 is processed 1st in the clustering result G1 illustrated in FIG. 7. In the cluster G12, a ratio of embeddings associated with the label 1 is calculated to be d1_1/d1=2/7≈0.29. A ratio of embeddings associated with the label 2 is calculated to be d1_2/d1=1/7≈0.14. A ratio of embeddings associated with the label 3 is calculated to be d1_3/d1=4/7≈0.57. The ratios of embeddings associated with those labels are not equal to or greater than the threshold T, and therefore the cluster G12 does not satisfy the occupancy condition.

In a case where it has been determined to be Yes in step S108, a process of subsequent step S109 is carried out. In step S109, the calculation section 13A adds, to the variable e, the number di of embeddings in the i-th cluster. This is because the i-th cluster satisfies the occupancy condition and therefore the di embeddings included in the cluster are all regarded as being associated with the occupying label.

In step S110, the calculation section 13A repeats the processes from step S105 while incrementing the iterator i.

In a case where it has been determined to be No in step S108, the process in step S110 is carried out without carrying out the process in step S109. That is, in a case where the i-th cluster does not satisfy the occupancy condition, the iterator i is incremented and the processes from step S105 are repeated without increasing the variable e.

The following description will discuss a case in which it has been determined to be No in step S105. In this case, the processes in steps S106 through S109 have been completed for all clusters included in the result of the clustering. That is, the variable e indicates a total number of embeddings included in a cluster that satisfies the occupancy condition among the plurality of clusters indicated by the clustering result. In this case, therefore, the process of subsequent step S111 is carried out.

In step S111, the calculation section 13A calculates, as an evaluation index indicating an evaluation of a clustering result, a ratio e/D of the total number e of embeddings included in one or more clusters that satisfy the occupancy condition relative to the total number D of embeddings subjected to clustering.

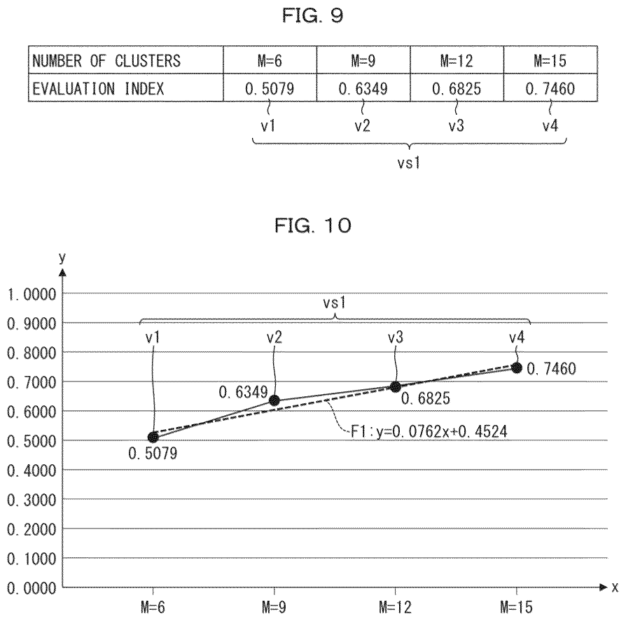

The calculation section 13A carries out such steps S101 through S111 for each of results of clustering carried out a plurality of times with respect to the same plurality of embeddings, and thus acquires an evaluation index series. FIG. 9 is a diagram illustrating an example of an evaluation index series obtained from the clustering results G1 through G4 with respect to the embedding set ES1. In FIG. 9, an evaluation index series vs1 is a sequence obtained by arranging evaluation indices v1, v2, v3, and v4 in ascending order of the number M of clusters. The evaluation index v1 is an evaluation index obtained from the clustering result G1 illustrated in FIG. 7 and corresponds to the number M of clusters=6. The evaluation index v2 is an evaluation index obtained from the clustering result G2 and corresponds to the number M of clusters=9. The evaluation index v3 is an evaluation index obtained from the clustering result G3 and corresponds to the number M of clusters=12. The evaluation index v4 is an evaluation index obtained from the clustering result G4 and corresponds to the number M of clusters=15.

This is the end of the description of the detailed example of step S13A. Next, in step S14A illustrated in FIG. 4, the evaluation section 14A evaluates quality of the embedding layer L1 based on the determination criterion with reference to the evaluation index series. For example, the evaluation result by the evaluation section 14A may indicate whether the quality of the embedding layer L1 is satisfactory or not in accordance with whether or not the determination criterion is satisfied. Two examples of the determination criterion will be described below.

A first example of the determination criterion is a criterion that a relationship between the number of clusters and an evaluation index satisfies a predetermined condition. For example, the determination criterion may include a condition for one or both of an inclination and an intercept in an approximate straight line obtained from an evaluation index series. Such an approximate straight line is obtained by carrying out linear approximation while using the evaluation index as an objective variable and the number of clusters as an explanatory variable.

FIG. 10 is a diagram for describing a first example of the determination criterion. In FIG. 10, the horizontal axis x indicates the number M of clusters, the vertical axis y indicates an evaluation index, and the evaluation index series vs1 illustrated in FIG. 9 is plotted. A linear function F1 represents a straight line obtained by linearly approximating the evaluation index series vs1, and has an inclination a=0.0762 and an intercept b=0.4524. For example, in a case where the determination criterion is “a>0 and b>0.4”, it is determined that the evaluation index series vs1 satisfies the determination criterion. For example, in a case where the determination criterion is “a>0 and b>0.8”, it is determined that the evaluation index series vs1 does not satisfy the determination criterion.

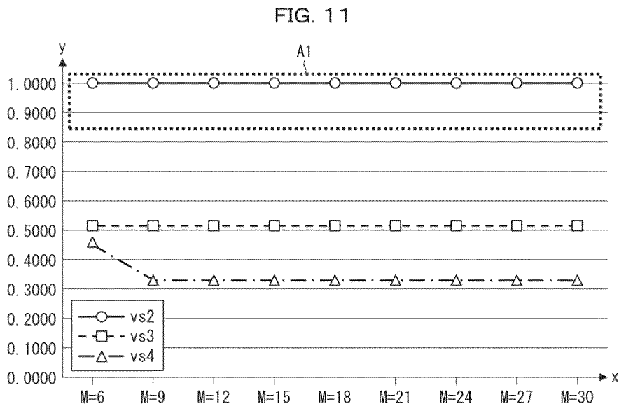

A second example of the determination criterion is a criterion that an evaluation index series is included in a predetermined region in a graph obtained by plotting the evaluation index series. The predetermined region may have a rectangular shape or may have another shape. FIG. 11 is a diagram for describing a second example of the determination criterion. In FIG. 11, the horizontal axis x indicates the number M of clusters, and the vertical axis y indicates an evaluation index. In FIG. 11, evaluation index series vs2, vs3, and vs4 obtained by a specific example described later are plotted. The evaluation index series vs2 is constituted by evaluation indices in respective results of clustering carried out nine times while varying the number M of clusters with respect to a plurality of embeddings obtained from a training data set DS2 (not illustrated). Note that the training data set DS2 includes three types of labels (N=3), that is, a label 1, a label 2, and a label 3. In the 9 times of clustering, a multiple of 3, which is the number N of label types, is employed as the number M of clusters. The evaluation index series vs3 and vs4 are also described in a manner similar to the series vs2, except that a training data set of interest is different. The evaluation index series vs3 is obtained from results of clustering with respect to an embedding set acquired from a training data set DS3 (not illustrated). The evaluation index series vs4 is obtained from results of clustering with respect to an embedding set acquired from a training data set DS4 (not illustrated). The training data sets DS3 and DS4 are also described similarly to the training data set DS2, except that a part of or all of training data pieces included are different.

In FIG. 11, a predetermined region A1 is defined as a determination criterion. The predetermined region A1 indicates a rectangular region in which y≥0.85. That is, in this case, the determination criterion is a criterion that an evaluation index is always 0.85 or more regardless of a change in the number M of clusters. The evaluation index series vs2 is included in the predetermined region A1, and is therefore determined to satisfy the determination criterion. The evaluation index series vs3 and vs4 are both not included in the predetermined region A1, and are therefore determined not to satisfy the determination criterion. This is the end of the description of the example of the determination criterion in step S14A.

In step S15A illustrated in FIG. 4, the output section 15A outputs, to the display apparatus 3, at least one selected from the group consisting of an evaluation result by the evaluation section 14A, a result of clustering by the clustering section 12A, and an evaluation index calculated by the calculation section 13A.

For example, information output to the display apparatus 3 may include, as a result of evaluation by the evaluation section 14A, information indicating whether quality of the embedding layer is satisfactory or not. An example of information indicating that the quality of the embedding layer is satisfactory is character information stating that “The embedding layer of this language processing model has been determined to be appropriate”. An example of information indicating that the quality of the embedding layer is not satisfactory is character information stating that “The embedding layer of this language processing model has been determined to be inappropriate. Please check the training data set and consider changing the pre-trained model”, or the like.

For example, information output to the display apparatus 3 may include, as a result of clustering by the clustering section 12A, an image (e.g., FIG. 7) in which figures indicating clusters are superimposed on a scatter diagram of embeddings which has been compressed in two dimensions.

For example, information output to the display apparatus 3 may include, as an evaluation index calculated by the calculation section 13A, an image (e.g., FIG. 10 or FIG. 11) in which a figure indicating a determination criterion is superimposed on a graph obtained by plotting an evaluation index series.

### (Variation 1)

The evaluation method S1A described above can be modified to include step S13B in place of step S13A. In step S13B, the calculation section 13A may calculate the evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by a result of clustering.

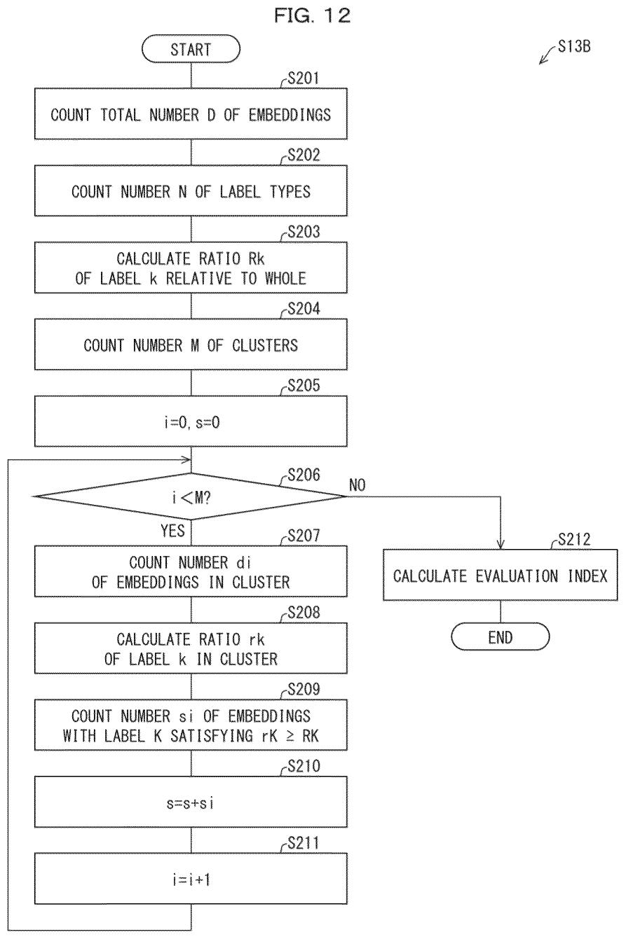

The remaining condition may be a condition that a first ratio relative to a second ratio satisfies a predetermined condition, where the first ratio indicates a ratio of one or more embeddings associated with a certain label in a certain cluster, and the second ratio indicates a ratio of training data pieces including the certain label in the whole of a plurality of training data pieces. The predetermined condition may be a condition that the first ratio is equal to or greater than the second ratio. Note, however, that the remaining condition is not limited to the above-described example. Here, in the certain cluster, embeddings associated with a label other than a label that satisfies the remaining condition are regarded as having been removed. Thus, one or more embeddings associated with the label that satisfies the remaining condition can be regarded as remaining in an i-th cluster. Hereinafter, the “embeddings associated with a label that satisfies the remaining condition in a certain cluster” is also referred to as “embeddings remaining in a certain cluster”. As the total number of embeddings remaining in each of a plurality of clusters indicated by a result of clustering increases, a result of the clustering is highly likely to be appropriate. Therefore, it is possible to calculate an evaluation index by referring to remaining embeddings. The following description will discuss a detailed example of the calculation process in step S13B, with reference to FIG. 12.

FIG. 12 is a flowchart illustrating a detailed example of a calculation process in step S13B. As illustrated in FIG. 12, the calculation process S13B includes steps S201 through S212. Steps S201 through S211 indicate a series of processes which is carried out for a single clustering result, and is repeated by the number of times clustering is carried out. The following description will mainly discuss an example in which steps S201 through S212 are carried out for the clustering result G1 illustrated in FIG. 7. Steps S201 through S212 are carried out similarly also for each of the clustering results G2 through G4.

In step S201, the calculation section 13A counts a total number D of embeddings which have been subjected to clustering. In the example of FIG. 6, the training data set DS1 includes 63 training data pieces D, and therefore D is 63.

In step S202, the calculation section 13A counts the number N of label types. In the example illustrated in FIG. 6, as described above, there are three types of labels, i.e., the label 1, the label 2, and the label 3. Therefore, the number N of label types is 3.

In step S203, the calculation section 13A calculates, for each of the N types of labels, a ratio Rk of one or more embeddings associated with a k-th label relative to the whole. The ratio Rk is an example of the second ratio. In the example illustrated in FIG. 6, 21 embeddings are associated with each of the label 1, the label 2, and the label 3. Therefore, R1 is 33.33%, R2 is 33.33%, and R3 is 33.33% (here, for simplification, a numerical value rounded up or down to the second decimal place is indicated as a ratio, and the same applies hereinafter).

In step S204, the calculation section 13A counts the number M of clusters. For example, in the clustering result G1 illustrated in FIG. 7, M is 6.

In step S205, the calculation section 13A initializes, to 0, an iterator i for sequentially processing a plurality of clusters which are included in a result of clustering of interest. Moreover, the calculation section 13A initializes, to 0, a variable s for counting a total number of one or more embeddings associated with a label that satisfies the remaining condition.

In step S206, the calculation section 13A determines whether or not i is smaller than M (that is, whether or not there is a cluster which has not been processed yet). In a case where it has been determined to be Yes in step S206, a series of processes in subsequent steps S207 through S210 is carried out with respect to an i-th cluster. A case in which it has been determined to be No in step S206 will be described later.

In step S207, the calculation section 13A counts a number di of embeddings which are included in the i-th cluster. For example, it is assumed that a cluster G11 is processed 0th in the clustering result G1 illustrated in FIG. 7. In this case, d0 is 11.

In step S208, the calculation section 13A calculates, in the i-th cluster, a ratio rk of embeddings associated with a k-th label for each of the N types of labels. The ratio rk is an example of the foregoing first ratio. The ratio rk is calculated by dividing the number of embeddings associated with the k-th label in the i-th cluster by the foregoing number di. For example, the following description will discuss a case where a cluster G11 is processed 0th in the clustering result G1 illustrated in FIG. 7. In this case, the number of embeddings associated with the label 1 is 0, and therefore r1=0/11=0.00%. The number of embeddings associated with the label 2 is 1, and therefore r2=1/19≈9.09%. The number of embeddings associated with the label 3 is 10, and therefore r3=10/11≈90.91%.

In step S209, the calculation section 13A determines that a K-th label that satisfies rK≥RK satisfies the remaining condition. Note that two or more types of labels may satisfy the remaining condition. In other words, a plurality of values may be specified as K. Moreover, the calculation section 13A counts a number si of one or more embeddings which remain in the i-th cluster. As described above, the one or more remaining embeddings are one or more embeddings associated with the label K that satisfies the remaining condition. For example, in the cluster G11, r1<R1 is satisfied, and therefore the label 1 does not satisfy the remaining condition. Since r2<R2 is satisfied, the label 2 does not satisfy the remaining condition. Since r3>R3 is satisfied, the label 3 satisfies the remaining condition. Therefore, a number s0 of embeddings which are associated with the label 3 and remain in the cluster G11 is 10.

In step S210, the calculation section 13A adds, to the variable s, the number si of embeddings which remain in the i-th cluster.

In step S211, the calculation section 13A repeats the processes from step S206 while incrementing the iterator i.

The following description will discuss a case in which it has been determined to be No in step S206. In this case, the processes in steps S207 through S210 have been completed for all clusters included in the result of the clustering. That is, the variable s indicates a total number of embeddings remaining in each of a plurality of clusters indicated by the clustering result. In this case, therefore, the process of subsequent step S212 is carried out.

In step S212, the calculation section 13A calculates, as an evaluation index indicating an evaluation of a clustering result, a ratio s/D of the total number s of embeddings remaining in each cluster relative to the total number D of embeddings subjected to clustering.

The calculation section 13A carries out such steps S201 through S212 for each of results of clustering carried out a plurality of times with respect to the same plurality of embeddings, and thus acquires an evaluation index series.

### (Variation 2)

The evaluation method S1A described above can be modified to include step S13C in place of step S13A. In step S13C, the calculation section 13A may calculate an evaluation index with reference to a result of comparing (i) the number of training data pieces (hereinafter referred to as a first number of pieces) including the same label among a plurality of training data pieces and (ii) the number of training data pieces (hereinafter referred to as a second number of pieces) included in one or more clusters each including at least one embedding generated from a training data piece including that label among a plurality of clusters indicated by a result of clustering.

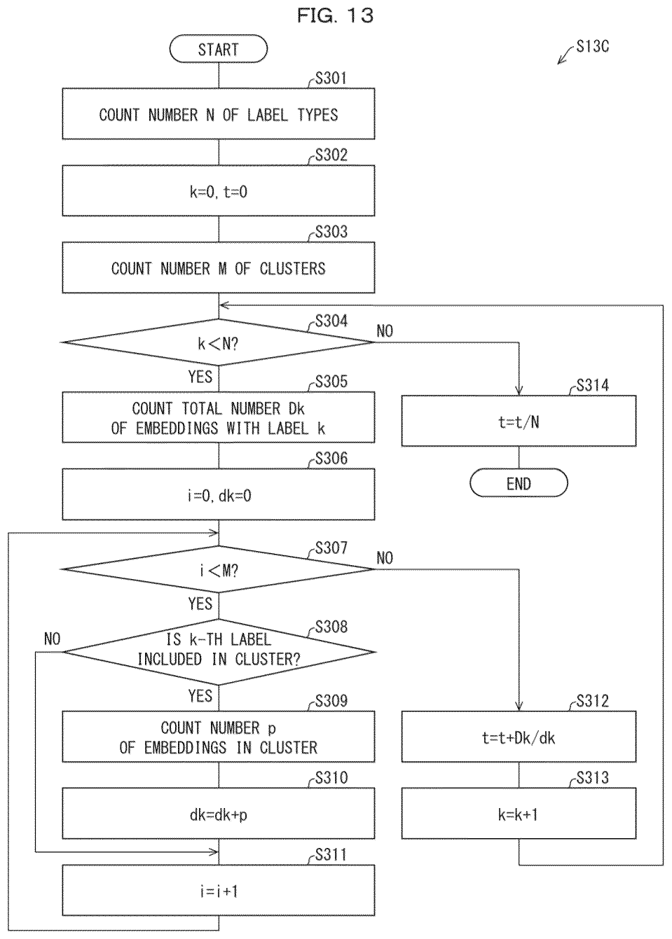

Here, it can be said that, as a difference between the first number of pieces and the second number of pieces is smaller, a degree is lower to which embeddings associated with another label are included in the cluster including the embeddings associated with the label. Therefore, it is highly likely that the result of the clustering is appropriate. Therefore, it is possible to calculate an evaluation index by referring to a result of comparing the first number of pieces and the second number of pieces. The following description will discuss a detailed example of the calculation process in step S13C, with reference to FIG. 13.

FIG. 13 is a flowchart illustrating a detailed example of a calculation process in step S13C. As illustrated in FIG. 13, the calculation process S13C includes steps S301 through S314. Steps S301 through S314 indicate a series of processes which is carried out for a single clustering result, and is repeated by the number of times clustering is carried out. The following description will mainly discuss an example in which steps S301 through S314 are carried out for the clustering result G1 illustrated in FIG. 7. Steps S301 through S314 are carried out similarly also for each of the clustering results G2 through G4.

In step S301, the calculation section 13A counts the number N of label types. In the example illustrated in FIG. 6, as described above, there are three types of labels, i.e., the label 1, the label 2, and the label 3. Therefore, the number N of label types is 3.

In step S302, the calculation section 13A initializes, to 0, an iterator i for sequentially processing a plurality of clusters which are included in a result of clustering of interest. Moreover, the calculation section 13A initializes, to 0, a variable t for adding a set product number. The set product number is a value obtained by dividing a total number (the foregoing first number of pieces) of embeddings associated with a certain label by a total number (the foregoing second number of pieces) of embeddings included in one or more clusters each including at least one embedding associated with that certain label. The set product number is an example of a number indicating a result of comparing the first number of pieces and the second number of pieces.

In step S303, the calculation section 13A counts the number M of clusters. For example, in the clustering result G1 illustrated in FIG. 7, M is 6.

In step S304, the calculation section 13A determines whether or not k is smaller than N (that is, whether or not there is a label which has not been processed yet). In a case where it has been determined to be Yes in step S304, a series of processes in subsequent steps S305 through S312 is carried out with respect to a k-th label. A case in which it has been determined to be No in step S304 will be described later.

In step S305, the calculation section 13A counts a total number Dk of embeddings which are associated with the k-th label. The total number Dk indicates the foregoing first number of pieces. In the clustering result G1 illustrated in FIG. 7, D1 is 21, D2 is 21, and D3 is 21.

In step S306, the calculation section 13A initializes, to 0, an iterator i for sequentially processing a plurality of clusters which are included in a result of clustering of interest. Moreover, the calculation section 13A initializes, to 0, a variable dk for counting a total number (the foregoing second number of pieces) of embeddings included in one or more clusters each including at least one embedding associated with the k-th label.

In step S307, the calculation section 13A determines whether or not i is smaller than M (that is, whether or not there is a cluster which has not been processed yet). In a case where it has been determined to be Yes in step S307, a series of processes in subsequent steps S308 through S310 is carried out with respect to an i-th cluster. A case in which it has been determined to be No in step S307 will be described later.

In step S308, the calculation section 13A determines whether or not at least one embedding associated with the k-th label is included in the i-th cluster. For example, in a case of the 1st label (label 1), there is no embedding associated with the label 1 in the cluster G11. Therefore, it is determined to be No. In the cluster G12, there are two embeddings associated with the label 1. Therefore, it is determined to be Yes. In a case where it has been determined to be Yes in step S308, processes from subsequent step S309 are carried out. In a case where it has been determined to be No in step S308, processes from step S311 described later are carried out without carrying out the processes in steps S309 and S310.

In step S309, the calculation section 13A counts a number p of embeddings which are included in the i-th cluster. For example, in a case where the cluster G11 is a subject in the clustering result G1 illustrated in FIG. 7, p is 11.

In step S310, the calculation section 13A adds, to the variable dk, the number p of embeddings in the i-th cluster.

In step S311, the calculation section 13A repeats the processes from step S307 while incrementing the iterator i.

The following description will discuss a case in which it has been determined to be No in step S307. In this case, for the k-th label of interest, the processes in steps S308 through S310 have been completed for all clusters included in the result of the clustering. That is, the variable dk indicates a total number (second number of pieces) of embeddings which are included in one or more clusters each including at least one k-th label. In this case, therefore, the process of subsequent step S312 is carried out.

In step S312, the calculation section 13A adds, to the variable t, a set product number Dk/dk for the k-th label.

In step S313, the calculation section 13A repeats the processes from step S304 while incrementing the iterator k.

The following description will discuss a case in which it has been determined to be No in step S304. In this case, the processes in steps S305 through S312 have been completed for all N types of labels. That is, the variable t indicates a total of set product numbers for each label. In this case, therefore, the process of subsequent step S314 is carried out.

In step S314, the calculation section 13A calculates, as an evaluation index indicating an evaluation of a clustering result, an average value t/N of set product numbers for each label.

The calculation section 13A carries out such steps S301 through S314 for each of results of clustering carried out a plurality of times with respect to the same plurality of embeddings, and thus acquires an evaluation index series.

### Specific Example

The following description will discuss a specific example in which an experiment was carried out to evaluate quality of the embedding layer L1 using the evaluation apparatus 1A. In this example, the quality of the embedding layer L1 was evaluated for training data sets DS2, DS3, and DS4 that differ from each other. As the evaluation index, three types of evaluation indices calculated by the calculation processes S13A, S13B, and S13C were used.

The training data set DS2 was generated by extracting articles of three types of categories A, B, and C from an existing news corpus, and included 2286 training data pieces. Each of the training data pieces included information in which an article is associated with any one of the three types of categories.

The training data set DS3 was generated by adding a training data set DSα including 2289 training data pieces to the training data set DS2, and included a total of 4575 training data pieces. The added training data set DSα was generated by extracting, from the news corpus, articles of three types of other categories different from all the categories A, B, and C, and disguising the extracted articles as any one of the categories A, B, and C. The disguising means that any one of categories A, B, and C is associated with an article of a category that is actually not the categories A, B, and C. The training data set DS3 was training data pieces approximately ½ of which included incorrect labels among the total of 4575 training data pieces.

The training data set DS4 was generated by adding a training data set DSβ including 4932 training data pieces to the training data set DS2, and included a total of 7218 training data pieces. The added training data set DSβ was generated by extracting, from the news corpus, articles of six types of other categories different from all the categories A, B, and C, and disguising the extracted articles as any one of the categories A, B, and C. The training data set DS4 was training data pieces approximately ⅔ of which included incorrect labels among the total of 7218 training data pieces.

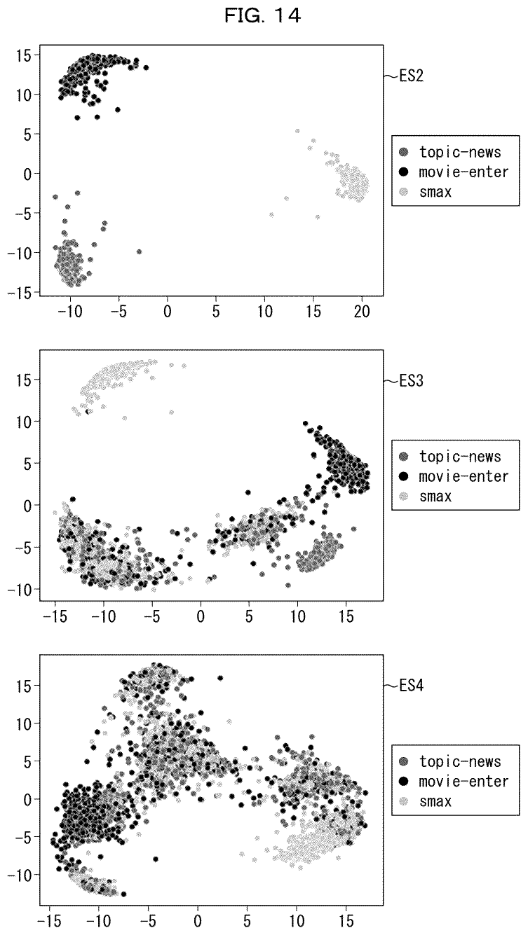

FIG. 14 is a scatter diagram in which embeddings (higher dimensions) acquired by the acquisition section 11A in this specific example are compressed to two dimensions and plotted. In FIG. 14, an embedding set ES2 indicates a plurality of embeddings obtained from the training data set DS2. An embedding set ES3 indicates a plurality of embeddings obtained from the training data set DS3. An embedding set ES4 indicates a plurality of embeddings obtained from the training data set DS4. The embedding set ES2 has been acquired from the training data set DS2 that does not include an incorrect training data piece. Therefore, as compared with the embedding sets ES3 and ES4 which have been acquired from the training data sets DS3 and DS4 including incorrect training data pieces, categories are dispersed so that the categories can be distinguished more clearly.

Results of evaluation carried out with respect to the embedding sets ES2, ES3, and ES4 using the evaluation index calculation process S13A are as described above with reference to FIG. 11. That is, the evaluation index series vs2 is included in the predetermined region A1, and is therefore determined to satisfy the determination criterion. In this case, in step S15A, quality of the embedding layer L1 is output as satisfactory. The evaluation index series vs3 and vs4 are both not included in the predetermined region A1, and are therefore determined not to satisfy the determination criterion. That is, the quality of the embedding layer L1 is evaluated to be not satisfactory. In this case, in step S15A, a message “The embedding layer of this language processing model has been determined to be inappropriate. Please check the training data set and consider changing the pre-trained model” is output. Thus, in a case where the quality of the training data set DS3 (or DS4) is not satisfactory, it can be seen that an appropriate evaluation result “Please check the training data set and consider changing the pre-trained model” is output.

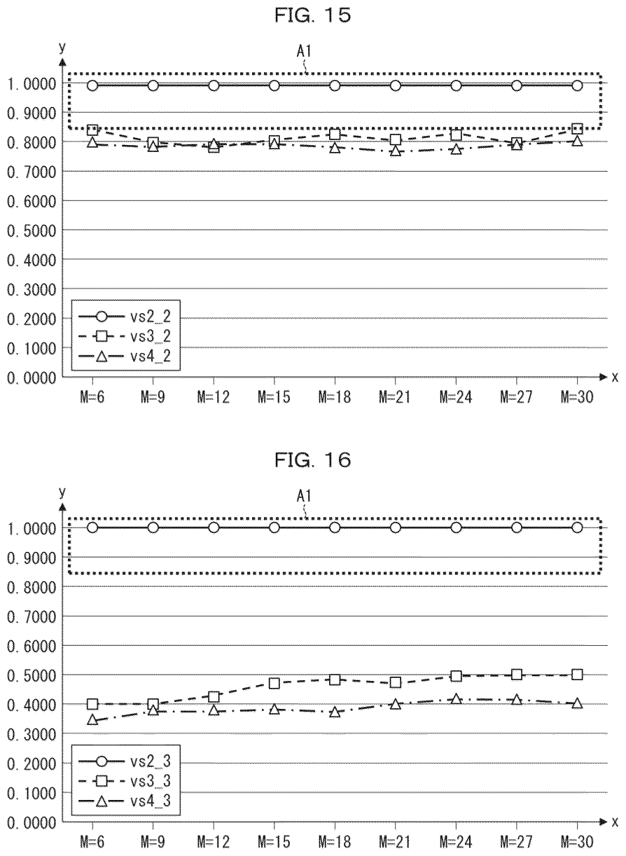

FIG. 15 is a diagram for describing an example of a result of evaluation carried out using the evaluation index calculation process S13B with respect to a result of clustering carried out a plurality of times with respect to the embedding set ES3. FIG. 15 is described similarly to FIG. 11 except that, instead of the evaluation index series vs2, vs3, and vs4, evaluation index series vs2_2, vs3_2, and vs4_2 are plotted. The evaluation index series vs2_2, vs3_2, and vs4_2 are each an evaluation index series calculated using the evaluation index calculation process S13B. In a case where the evaluation index calculation process S13B is used also, the evaluation index series vs2_2 is determined to satisfy the determination criterion because the evaluation index series vs2_2 is included in the predetermined region A1. The evaluation index series vs3_2 and vs4_2 are both not included in the predetermined region A1, and are therefore determined not to satisfy the determination criterion. Therefore, in the case where the evaluation index calculation process S13B is used also, as with the case where the evaluation index calculation process S13A is used, in a case where the quality of the training data set DS3 (or DS4) is not satisfactory, it can be seen that an appropriate evaluation result “Please check the training data set and consider changing the pre-trained model” is output.

FIG. 16 is a diagram for describing an example of a result of evaluation carried out using the evaluation index calculation process S13C with respect to a result of clustering carried out a plurality of times with respect to the embedding set ES4. FIG. 16 is described similarly to FIG. 11 except that, instead of the evaluation index series vs2, vs3, and vs4, evaluation index series vs2_3, vs3_3, and vs4_3 are plotted. The evaluation index series vs2_3, vs3_3, and vs4_3 are each an evaluation index series calculated using the evaluation index calculation process S13C. In a case where the evaluation index calculation process S13C is used also, the evaluation index series vs2_3 is determined to satisfy the determination criterion because the evaluation index series vs2_3 is included in the predetermined region A1. The evaluation index series vs3_3 and vs4_3 are both not included in the predetermined region A1, and are therefore determined not to satisfy the determination criterion. Therefore, in the case where the evaluation index calculation process S13C is used also, as with the case where the evaluation index calculation process S13A is used, in a case where the quality of the training data set DS3 (or DS4) is not satisfactory, it can be seen that an appropriate evaluation result “Please check the training data set and consider changing the pre-trained model” is output.

### (Variation 3)

The evaluation method S1A can be modified as follows. In a case where the evaluation apparatus 1A has determined that an evaluation result (hereinafter referred to as a first evaluation result) of quality of the embedding layer obtained by carrying out steps S11A through S14A for the first time does not satisfy the determination criterion, the evaluation apparatus 1A may carry out steps S11A through S14A for the second time. In steps S11A through S14A for the second time, the training data set DS1 identical to that for the first time and a language processing model M2-1 different from that for the first time are used. As described above, the language processing model M2-1 can be a model generated using the same training data set DS1 based on a pre-trained model M1-1 different from the pre-trained model M1. By carrying out steps S11A through S14A for the second time, an evaluation result (hereinafter referred to as a second evaluation result) of the quality of the embedding layer is obtained.

In this variation, after step S14A for the second time is carried out, the evaluation section 14A determines whether or not the second evaluation result satisfies the determination criterion. In a case where the second evaluation result does not satisfy the determination criterion as with the first evaluation result, the evaluation section 14A evaluates that the quality of the training data set DS1 does not satisfy the criterion. That is, a cause of a case where performance of the language processing models M2 and M2-1 is not satisfactory is narrowed down to the training data set DS1.

The evaluation section 14A may carry out steps S11A through S14A not only twice but also a plurality of times (e.g., for the second time, third time, and so forth) in a case where the first evaluation result does not satisfy the determination criterion. For example, in a case where the first evaluation result does not satisfy the determination criterion, the evaluation section 14A may obtain two or more evaluation results (second evaluation result, third evaluation result, and the like) by using the same training data set DS1 and two or more different language processing models (M2-1, M2-2, and the like). For example, the plurality of language processing models (M2, M2-1, M2-2, and the like) may be obtained by fine-tuning a plurality of different pre-trained models (M1, M1-1, M1-2, and the like) using the same training data set DS1. In this case, the evaluation section 14A may evaluate quality of the training data set DS1 based on a statistical value of three or more evaluation results (first evaluation result, second evaluation result, third evaluation result, and the like). For example, in a case where a predetermined proportion or more of the three or more evaluation results does not satisfy the criterion, the evaluation section 14A may evaluate that the quality of the training data set DS1 does not satisfy the criterion.

In this case, in step S15A, the output section 15A may output information indicating that the quality of the training data set DS1 does not satisfy the criterion. Examples of such information include character information stating that “None of the embedding layers of the plurality of language processing models generated using the same training data set has been determined to be appropriate. Please confirm that there is a probable cause in the training data set”, or the like.

In a case where the first evaluation result satisfies the determination criterion, the evaluation apparatus 1A may carry out step S15A in a manner similar to that described above, without carrying out steps S11A through S14A for the second and subsequent times. The evaluation apparatus 1A may carry out steps S11A through S14A for the second and subsequent times, regardless of the first evaluation result.

### Application Example

The evaluation apparatus (1, 1A) in accordance with each of the foregoing example embodiments can be applied, for example, in the field of health care or medical care. For example, by using the evaluation apparatus (1, 1A) for a language processing model which has been subjected to machine learning so as to classify electronic medical records which are recorded by doctors for patients, the evaluation apparatus (1, 1A) can be used for an application of narrowing down a cause in a case where performance of the language processing model is poor.

### (Example Advantage of Evaluation Apparatus 1A)

As described above, the evaluation apparatus 1A employs the configuration in which the clustering section 12 carries out clustering a plurality of times while varying the number of clusters, and the evaluation section 14 evaluates quality of the embedding layer based on evaluation indices indicating evaluations of respective results of clustering which has been carried out the plurality of times. According to the above configuration, it is possible to bring about an example advantage of evaluating quality of an embedding layer with higher accuracy, as compared with a case where evaluation is based on an evaluation index indicating an evaluation of a result of a single time of clustering, in addition to the example advantage brought about by the evaluation apparatus 1.

The evaluation apparatus 1A employs the configuration in which the calculation section 13A calculates an evaluation index with reference to a cluster that satisfies an occupancy condition among a plurality of clusters indicated by a result of clustering, the occupancy condition being a condition for regarding a cluster of interest as being occupied by a plurality of embeddings which have been generated from a plurality of training data pieces including the same label. According to the above configuration, it is possible to bring about an example advantage of evaluating quality of an embedding layer with higher accuracy, in addition to the example advantage brought about by the evaluation apparatus 1.

The evaluation apparatus 1A employs the configuration in which the calculation section 13A calculates an evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by a result of clustering. According to the above configuration, it is possible to bring about an example advantage of evaluating quality of an embedding layer with higher accuracy, in addition to the example advantage brought about by the evaluation apparatus 1.

The evaluation apparatus 1A employs the configuration in which the calculation section 13A calculates an evaluation index with reference to a result of comparing (1) the number of training data pieces including the same label among a plurality of training data pieces and (2) the number of embeddings included in one or more clusters each including at least one embedding generated from a training data piece including that label among a plurality of clusters indicated by a result of clustering. According to the above configuration, it is possible to bring about an example advantage of evaluating quality of an embedding layer with higher accuracy, in addition to the example advantage brought about by the evaluation apparatus 1.

The evaluation apparatus 1A employs the configuration of further including the output section 15A that outputs at least one selected from the group consisting of a result of evaluating quality of the embedding layer, a result of clustering, and an evaluation index. According to the above configuration, it is possible to bring about an example advantage of allowing a user to recognize at least one selected from the group consisting of a result of evaluating quality of the embedding layer, a result of clustering, and an evaluation index, in addition to the example advantage brought about by the evaluation apparatus 1.

### (Other Variation)

In the foregoing second example embodiment, an example has been described in which a language processing model is a model that carries out a classification task. Note, however, that the language processing model may be a model that carries out a language processing task other than the classification task.

In the foregoing second example embodiment, the evaluation apparatus 1A has been described as being included in the evaluation system 10. However, the evaluation apparatus 1A does not necessarily need to be included in the evaluation system 10. For example, the evaluation apparatus 1A does not need to be able to access the training data set DS1 itself and the embedding layer L1 itself, provided that the evaluation apparatus 1A is accessible to the storage apparatus in which embeddings are stored which have been generated using the embedding layer L1 for respective training data pieces included in the training data set DS1.

### Software Implementation Example

Some or all of the functions of each of the evaluation apparatuses 1 and 1A (hereinafter referred to as “each of the apparatuses”) may be implemented by hardware such as an integrated circuit (IC chip), or may be implemented by software.

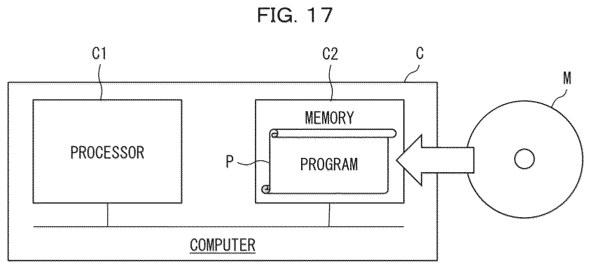

In the latter case, each of the apparatuses is implemented by, for example, a computer that executes instructions of a program that is software implementing the foregoing functions. FIG. 17 illustrates an example of such a computer (hereinafter, referred to as “computer C”). FIG. 17 is a block diagram illustrating a hardware configuration of the computer C which functions as each of the apparatuses.

The computer C includes at least one processor C1 and at least one memory C2. The memory C2 stores a program P for causing the computer C to operate as each of the apparatuses. The processor C1 of the computer C retrieves the program P from the memory C2 and executes the program P, so that the functions of each of the apparatuses are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded in a case where the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark A

The present disclosure includes techniques described in supplementary notes below. Note, however, that the present invention is not limited to the techniques described in supplementary notes below, but may be altered in various ways by a skilled person within the scope of the claims.

### (Supplementary Note A1)

An evaluation apparatus including: an acquisition means for acquiring embeddings for natural language sentences that are respectively included in a plurality of training data pieces, the embeddings having been generated with use of an embedding layer included in a language processing model; a clustering means for carrying out clustering of the embeddings; a calculation means for calculating, with reference to labels included in the respective plurality of training data pieces, an evaluation index indicating an evaluation of a result of the clustering; and an evaluation means for evaluating quality of the embedding layer based on the evaluation index.

### (Supplementary Note A2)

The evaluation apparatus according to supplementary note A1, in which: the clustering means carries out the clustering a plurality of times while varying the number of clusters; and the evaluation means evaluates quality of the embedding layer based on evaluation indices indicating evaluations of respective results of the clustering which has been carried out the plurality of times.

### (Supplementary Note A3)

The evaluation apparatus according to supplementary note A1 or A2, in which: the calculation means calculates the evaluation index with reference to a cluster that satisfies an occupancy condition among a plurality of clusters indicated by the result of the clustering, the occupancy condition being a condition for regarding a cluster of interest as being occupied by a plurality of embeddings which have been generated from a plurality of training data pieces including the same label.

### (Supplementary Note A4)

The evaluation apparatus according to any one of supplementary notes A1 through A3, in which: the calculation means calculates the evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by the result of the clustering.

### (Supplementary Note A5)

The evaluation apparatus according to any one of supplementary notes A1 through A4, in which: the calculation means calculates the evaluation index with reference to a result of comparing (1) the number of training data pieces including the same label among the plurality of training data pieces and (2) the number of embeddings included in one or more clusters each including at least one embedding generated from a training data piece including that label among a plurality of clusters indicated by the result of the clustering.

### (Supplementary Note A6)

The evaluation apparatus according to any one of supplementary notes A1 through A5, further including: an output means for outputting at least one selected from the group consisting of a result of evaluating quality of the embedding layer, the result of the clustering, and the evaluation index.

### Additional Remark B

The present disclosure includes techniques described in supplementary notes below. Note, however, that the present invention is not limited to the techniques described in supplementary notes below, but may be altered in various ways by a skilled person within the scope of the claims.

### (Supplementary Note B1)

An evaluation method, including: an acquisition process in which at least one processor acquires embeddings for natural language sentences that are respectively included in a plurality of training data pieces, the embeddings having been generated with use of an embedding layer included in a language processing model; a clustering process in which the at least one processor carries out clustering of the embeddings; a calculation process in which the at least one processor calculates, with reference to labels included in the respective plurality of training data pieces, an evaluation index indicating an evaluation of a result of the clustering; and an evaluation process in which the at least one processor evaluates quality of the embedding layer based on the evaluation index.

### (Supplementary Note B2)

The evaluation method according to supplementary note B1, in which: in the clustering process, the at least one processor carries out the clustering a plurality of times while varying the number of clusters; and in the evaluation process, the at least one processor evaluates quality of the embedding layer based on evaluation indices indicating evaluations of respective results of the clustering which has been carried out the plurality of times.

### (Supplementary Note B3)

The evaluation method according to supplementary note B1 or B2, in which: in the calculation process, the at least one processor calculates the evaluation index with reference to a cluster that satisfies an occupancy condition among a plurality of clusters indicated by the result of the clustering, the occupancy condition being a condition for regarding a cluster of interest as being occupied by a plurality of embeddings which have been generated from a plurality of training data pieces including the same label.

### (Supplementary Note B4)

The evaluation method according to any one of supplementary notes B1 through B3, in which: in the calculation process, the at least one processor calculates the evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by the result of the clustering.

### (Supplementary Note B5)

The evaluation method according to any one of supplementary notes B1 through B4, in which: in the calculation process, the at least one processor calculates the evaluation index with reference to a result of comparing (1) the number of training data pieces including the same label among the plurality of training data pieces and (2) the number of embeddings included in one or more clusters each including at least one embedding generated from a training data piece including that label among a plurality of clusters indicated by the result of the clustering.

(Supplementary Note B6)

The evaluation method according to any one of supplementary notes B1 through B5, further including: an output process in which the at least one processor outputs at least one selected from the group consisting of a result of evaluating quality of the embedding layer, the result of the clustering, and the evaluation index.

### Additional Remark C

The present disclosure includes techniques described in supplementary notes below. Note, however, that the present invention is not limited to the techniques described in supplementary notes below, but may be altered in various ways by a skilled person within the scope of the claims.

### (Supplementary Note C1)

A program for causing a computer to function as an evaluation apparatus, the program causing the computer to function as: an acquisition means for acquiring embeddings for natural language sentences that are respectively included in a plurality of training data pieces, the embeddings having been generated with use of an embedding layer included in a language processing model; a clustering means for carrying out clustering of the embeddings; a calculation means for calculating, with reference to labels included in the respective plurality of training data pieces, an evaluation index indicating an evaluation of a result of the clustering; and an evaluation means for evaluating quality of the embedding layer based on the evaluation index.

### (Supplementary Note C2)

The program according to supplementary note C1, in which: the clustering means carries out the clustering a plurality of times while varying the number of clusters; and the evaluation means evaluates quality of the embedding layer based on evaluation indices indicating evaluations of respective results of the clustering which has been carried out the plurality of times.

### (Supplementary Note C3)

The program according to supplementary note C1 or C2, in which: the calculation means calculates the evaluation index with reference to a cluster that satisfies an occupancy condition among a plurality of clusters indicated by the result of the clustering, the occupancy condition being a condition for regarding a cluster of interest as being occupied by a plurality of embeddings which have been generated from a plurality of training data pieces including the same label.

### (Supplementary Note C4)

The program according to any one of supplementary notes C1 through C3, in which: the calculation means calculates the evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by the result of the clustering.

### (Supplementary Note C5)

The program according to any one of supplementary notes C1 through C4, in which: the calculation means calculates the evaluation index with reference to a result of comparing (1) the number of training data pieces including the same label among the plurality of training data pieces and (2) the number of embeddings included in one or more clusters each including at least one embedding generated from a training data piece including that label among a plurality of clusters indicated by the result of the clustering.

### (Supplementary Note C6)

The program according to any one of supplementary notes C1 through C5, which further causes the computer to function as: an output means for outputting at least one selected from the group consisting of a result of evaluating quality of the embedding layer, the result of the clustering, and the evaluation index.

### Additional Remark D

The present disclosure includes techniques described in supplementary notes below. Note, however, that the present invention is not limited to the techniques described in supplementary notes below, but may be altered in various ways by a skilled person within the scope of the claims.

### (Supplementary Note D1)

An evaluation apparatus, including at least one processor, the at least one processor carrying out: an acquisition process of acquiring embeddings for natural language sentences that are respectively included in a plurality of training data pieces, the embeddings having been generated with use of an embedding layer included in a language processing model; a clustering process of carrying out clustering of the embeddings; a calculation process of calculating, with reference to labels included in the respective plurality of training data pieces, an evaluation index indicating an evaluation of a result of the clustering; and an evaluation process of evaluating quality of the embedding layer based on the evaluation index.

Note that the evaluation apparatus may further include a memory. In the memory, a program for causing the at least one processor to carry out the processes can be stored.

### (Supplementary Note D2)

The evaluation apparatus according to supplementary note D1, in which: in the clustering process, the at least one processor carries out the clustering a plurality of times while varying the number of clusters; and in the evaluation process, the at least one processor evaluates quality of the embedding layer based on evaluation indices indicating evaluations of respective results of the clustering which has been carried out the plurality of times.

### (Supplementary Note D3)

The evaluation apparatus according to supplementary note D1 or D2, in which: in the calculation process, the at least one processor calculates the evaluation index with reference to a cluster that satisfies an occupancy condition among a plurality of clusters indicated by the result of the clustering, the occupancy condition being a condition for regarding a cluster of interest as being occupied by a plurality of embeddings which have been generated from a plurality of training data pieces including the same label.

### (Supplementary Note D4)

The evaluation apparatus according to any one of supplementary notes D1 through D3, in which: in the calculation process, the at least one processor calculates the evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by the result of the clustering.

### (Supplementary Note D5)

The evaluation apparatus according to any one of supplementary notes D1 through D4, in which: in the calculation process, the at least one processor calculates the evaluation index with reference to a result of comparing (1) the number of training data pieces including the same label among the plurality of training data pieces and (2) the number of embeddings included in one or more clusters each including at least one embedding generated from a training data piece including that label among a plurality of clusters indicated by the result of the clustering.

### (Supplementary Note D6)

The evaluation apparatus according to any one of supplementary notes D1 through D5, in which: the at least one processor further carries out an output process of outputting at least one selected from the group consisting of a result of evaluating quality of the embedding layer, the result of the clustering, and the evaluation index.

### Additional Remark E

The present disclosure includes techniques described in supplementary notes below. Note, however, that the present invention is not limited to the techniques described in supplementary notes below, but may be altered in various ways by a skilled person within the scope of the claims.

### (Supplementary Note E1)

A non-transitory storage medium storing a program for causing a computer to function as an evaluation apparatus, the program causing the computer to carry out: an acquisition process of acquiring embeddings for natural language sentences that are respectively included in a plurality of training data pieces, the embeddings having been generated with use of an embedding layer included in a language processing model; a clustering process of carrying out clustering of the embeddings; a calculation process of calculating, with reference to labels included in the respective plurality of training data pieces, an evaluation index indicating an evaluation of a result of the clustering; and an evaluation process of evaluating quality of the embedding layer based on the evaluation index.

### REFERENCE SIGNS LIST

1, 1A: Evaluation apparatus
2: Training apparatus
3: Display apparatus
10: Evaluation system
11, 11A: Acquisition section
12, 12A: Clustering section
13, 13A: Calculation section
14, 14A: Evaluation section
15A: Output section
C1: Processor
C2: Memory

1. An evaluation apparatus, comprising at least one processor, the at least one processor carrying out:
an acquisition process of acquiring embeddings for natural language sentences that are respectively included in a plurality of training data pieces, the embeddings having been generated with use of an embedding layer included in a language processing model;
a clustering process of carrying out clustering of the embeddings;
a calculation process of calculating, with reference to labels included in the respective plurality of training data pieces, an evaluation index indicating an evaluation of a result of the clustering; and
an evaluation process of evaluating quality of the embedding layer based on the evaluation index.

2. The evaluation apparatus according to claim 1, wherein:
in the clustering process, the at least one processor carries out the clustering a plurality of times while varying the number of clusters; and
in the evaluation process, the at least one processor evaluates quality of the embedding layer based on evaluation indices indicating evaluations of respective results of the clustering which has been carried out the plurality of times.

3. The evaluation apparatus according to claim 1, wherein:
in the calculation process, the at least one processor calculates the evaluation index with reference to a cluster that satisfies an occupancy condition among a plurality of clusters indicated by the result of the clustering, the occupancy condition being a condition for regarding a cluster of interest as being occupied by a plurality of embeddings which have been generated from a plurality of training data pieces including the same label.

4. The evaluation apparatus according to claim 1, wherein:
in the calculation process, the at least one processor calculates the evaluation index with reference to one or more embeddings which have been generated from a plurality of training data pieces including a label that satisfies a remaining condition, the remaining condition being a condition for regarding an embedding of interest as remaining without being removed from each of a plurality of clusters indicated by the result of the clustering.

5. The evaluation apparatus according to claim 1, wherein:
in the calculation process, the at least one processor calculates the evaluation index with reference to a result of comparing (1) the number of training data pieces including the same label among the plurality of training data pieces and (2) the number of embeddings included in one or more clusters each including at least one embedding generated from a training data piece including that label among a plurality of clusters indicated by the result of the clustering.

6. The evaluation apparatus according to claim 1, wherein:
the at least one processor further carries out an output process of outputting at least one selected from the group consisting of a result of evaluating quality of the embedding layer, the result of the clustering, and the evaluation index.

7. An evaluation method, comprising:
an acquisition process in which at least one processor acquires embeddings for natural language sentences that are respectively included in a plurality of training data pieces, the embeddings having been generated with use of an embedding layer included in a language processing model;
a clustering process in which the at least one processor carries out clustering of the embeddings;
a calculation process in which the at least one processor calculates, with reference to labels included in the respective plurality of training data pieces, an evaluation index indicating an evaluation of a result of the clustering; and
an evaluation process in which the at least one processor evaluates quality of the embedding layer based on the evaluation index.

8. A non-transitory storage medium storing a program for causing a computer to function as an evaluation apparatus, the program causing the computer to carry out:
an acquisition process of acquiring embeddings for natural language sentences that are respectively included in a plurality of training data pieces, the embeddings having been generated with use of an embedding layer included in a language processing model;
a clustering process of carrying out clustering of the embeddings;
a calculation process of calculating, with reference to labels included in the respective plurality of training data pieces, an evaluation index indicating an evaluation of a result of the clustering; and
an evaluation process of evaluating quality of the embedding layer based on the evaluation index.
